(19) United States
(12) Patent Application Publication
(10) Pub. No.: US 2010/0017920 A1
(43) Pub. Date: Jan. 21, 2010

(54) SCANNING PROBE MICROSCOPE WITH TILTED SAMPLE STAGE

(76) Inventors: San-IL Park, Seongnam-city (KR); Yong-Seok Kim, Seoul (KR); Jitae Kim, Anyang-city (KR); Joonhul Kim, Seoul (KR); Hyunwoo Lee, Suwon-city (KR)

Correspondence Address: PATTERSON & SHERIDAN, L.L.P., 3040 POST OAK BOULEVARD, SUITE 1500, HOUSTON, TX, 77056, US

(21) Appl. No.: 12/502,177

(22) Filed: Jul. 13, 2009

Related U.S. Application Data
(60) Provisional application No. 61/082,469, filed on Jul. 21, 2008.

(51) Int. Cl. G01N 13/10

(52) U.S. Cl. 850/1; 250/307

(57) ABSTRACT

A scanning probe microscope has a tilting stage on which a sample is mounted. The sample is scanned back and forth with the stage being tilted clockwise during a forward scan and counterclockwise during a reverse scan. A first surface contour of the sample is determined from the response of the probe and the tilt angle of the stage during the forward scan. A second surface contour of the sample is determined from the response of the probe and the tilt angle of the stage during the reverse scan. A final surface contour of the sample is obtained by combining the first and second surface contours.

### CROSS-REFERENCE TO RELATED APPLICATIONS

This application claims the benefit of U.S. provisional patent application Ser. No. 61/082,469, filed Jul. 21, 2008, which is herein incorporated by reference.

### BACKGROUND OF THE INVENTION

1. Field of the Invention

The present invention relates to a scanning probe microscope (SPM), and more particularly, to an SPM that can analyze characteristics of samples using a tilted sample stage.

2. Description of the Related Art

Scanning probe microscopes (SPMs) are used to obtain nanoscale images of topographical or other features of a sample. Various improvements in SPMs have been developed. U.S. patent application Ser. No. 10/077,835, which is incorporated by reference herein, discloses an SPM having two scanners that are physically separated. The first scanner is used to scan a sample within a plane and the second scanner is used to scan a probe tip in a direction that is perpendicular to the plane. The physical separation of the two scanners eliminates crosstalk between the two scanners.

As a way to measure samples having an overhang structure, a method using a probe 10 illustrated in FIG. 1 has been proposed. Probe 10, which is moved in the l1 direction, has a protrusion 10a on its front end so that correct data related to a sample 20 having an overhang structure 20a can be obtained using the protrusion 10a. Probe 10 is, however, difficult and costly to manufacture. In addition, the method using probe 10 is not as accurate as conventional SPMs because the probe tip is not as sharp as probe tips of conventional SPMs.

U.S. patent application Ser. No. 11/601,144, also incorporated by reference herein, discloses another SPM that is capable of measuring samples having an overhang structure. In this SPM, a first scanner is used to scan a sample 200 within a plane and a second scanner is used to scan the probe tip in a direction (l2) that is not perpendicular to the plane. As illustrated in FIG. 2, with this arrangement, a probe tip 120 can reach a side surface 200a of an overhang structure so that the side surface 200a can be probed. Also, probe tip 120 is as sharp as probe tips of conventional SPMs. Therefore, measurement results generated using this arrangement is as accurate as conventional SPMs.

### SUMMARY OF THE INVENTION

The present invention provides an apparatus and a method for accurately characterizing difficult features on a sample surface such as overhang structures and trenches. According to one embodiment, the sample being measured is mounted on a tilting stage and scanned back and forth with the stage being tilted clockwise during a forward scan and counterclockwise during a reverse scan. A first surface contour of the sample is determined from the response of a probe and the tilt angle of the stage during the forward scan. A second surface contour of the sample is determined from the response of the probe and the tilt angle of the stage during the reverse scan. A final surface contour of the sample is obtained by combining the first and second surface contours.

A scanning probe microscope according to an embodiment of the invention includes a probe, a tilting stage defining a sample measurement plane that is not perpendicular to the first direction, and first and second scanners. The first scanner moves the probe in a first direction and a second scanner is used for scanning the sample within a plane defined by second and third directions. The scanning probe microscope further includes a controller that is programmed to generate measurement results based on the movements of the probe in the first direction and an angle by which the sample measurement plane is tilted with respect to a plane that is perpendicular to the first direction.

A method for measuring a sample, according to an embodiment of the invention, uses a scanning probe microscope having a probe, a sample stage on which a sample is mounted, a first scanner for moving the probe in a first direction, and second scanner for scanning the sample in second and third directions. The method includes the steps of tilting the sample stage so that the sample stage defines a sample measurement plane that is not perpendicular to the first direction, and scanning the sample within a plane defined by the second and third directions and monitoring movements of the probe in the first direction during said scanning.

A method for measuring a sample, according to another embodiment of the invention, uses a scanning probe microscope having a probe, a sample stage on which a sample is mounted, a probe scanner and a sample scanner. The method includes the steps of scanning the sample with a sample measurement plane being tilted clockwise with respect to a plane that is perpendicular to a scanning direction of the probe scanner, and scanning the sample with the sample measurement plane being tilted counterclockwise with respect to the plane that is perpendicular to the scanning direction of the probe scanner. The scanning directions in these two steps are opposite to each other.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram of an overhang structure being probed by a boot-shaped tip.

FIG. 2 is a conceptual diagram of an overhang structure being probed in a direction that is not perpendicular to a scanning plane of the overhang structure.

FIG. 3 is an SPM according to a first embodiment of the invention.

FIG. 4 illustrates a mechanism for tilting a sample stage.

FIG. 5A is a schematic illustration of a sample stage with a clockwise tilt.

FIG. 5B illustrates the scanning of a sample mounted on a stage with a clockwise tilt.

FIG. 5C is a schematic illustration of a sample stage with a counterclockwise tilt.

FIG. 5D illustrates the scanning of a sample mounted on a stage with a counterclockwise tilt.

FIG. 6 is a flow diagram of a method for measuring a sample using an SPM, according to an embodiment of the invention.

FIG. 7A illustrates an image generated from measurements of a sample mounted on a stage with a clockwise tilt.

FIG. 7B illustrates an image generated from measurements of a sample mounted on a stage with a counterclockwise tilt.

FIG. 7C illustrates an image generated from combining measurements of a sample mounted on a stage with a clockwise tilt and measurements of a sample mounted on a stage with a counterclockwise tilt.

FIG. 8 is an SPM according to a second embodiment of the invention.

FIGS. 9A and 9B illustrate sample scanning directions with respect to a tilted sample measurement plane in the SPM of FIG. 8.

FIG. 10 illustrates a scanner used in an SPM according to a third embodiment of the invention.

FIGS. 11A and 11B illustrate sample scanning directions with respect to a tilted sample measurement plane when the scanner of FIG. 10 is used.

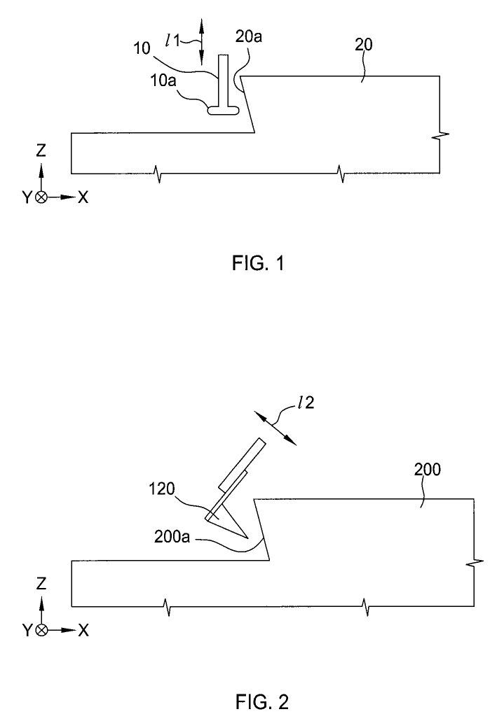

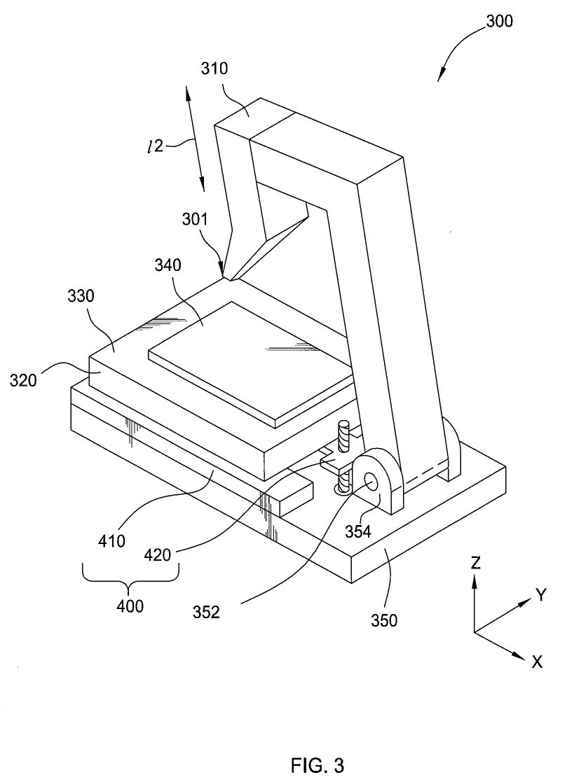

For clarity, identical reference numbers have been used, where applicable, to designate identical elements that are common between figures. It is contemplated that features of one embodiment may be incorporated in other embodiments without further recitation.

### DETAILED DESCRIPTION

FIG. 3 is an SPM 300 according to a first embodiment of the invention. SPM 300 includes a probe 301, a first scanner 310, a second scanner 320, and a sample stage 330. Sample 340 is placed on sample stage 330. First scanner 310 is coupled to probe 301 and changes the position of probe 301 along a first direction (z direction). Second scanner 320 defines sample stage 330 on an upper surface thereof and changes the position of sample stage 330 along second and third directions (x and y directions). First scanner 310 is supported on a frame 350 of SPM 300 through a pivot point 352. An actuator 354 is provided to rotate first scanner 310 about pivot point 352 and change the scanning direction of probe 301. SPM also includes a mechanism 400 for tilting sample stage 330. Tilting mechanism 400 includes a base unit 410 and a tilting unit 420. Further details of SPM 300 are described in U.S. patent application Ser. No. 11/601,144.

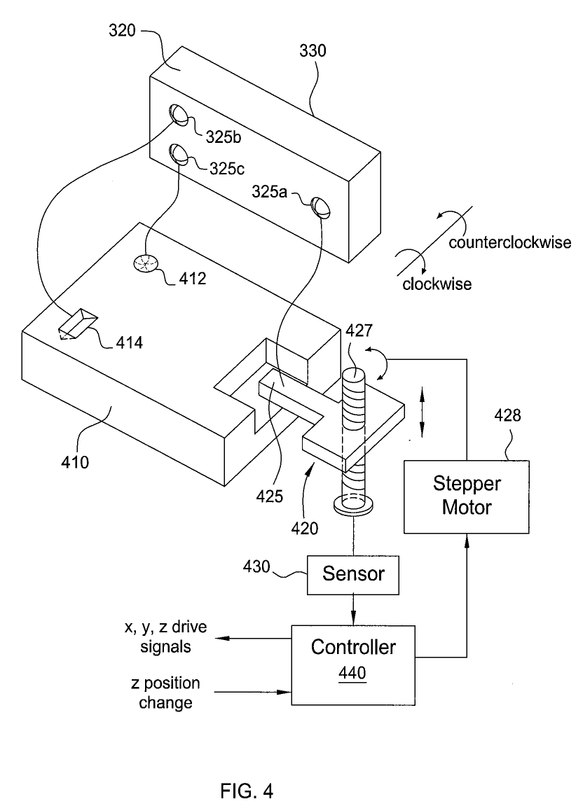

FIG. 4 illustrates a mechanism 400 for tilting sample stage 330 in further detail. As illustrated, second scanner 320, on which sample stage 330 is formed, has spherical balls 325a, 325b, 325c formed on its bottom surface. Spherical ball 325a mounts on a top surface 425 of tilting unit 420. Spherical ball 325b is received within a conical groove 412 of base unit 410 and spherical ball 325c is received within a V-shaped groove 414 of base unit 410. By rotation of lead screw 427 using a stepper motor 428, tilting unit 420 can be raised or lowered. When tilting unit 420 is raised, sample stage 330 tilts in a counterclockwise direction. When tilting unit 420 is lowered, sample stage 330 tilts in a clockwise direction. The rotation of lead screw 427 is sensed by a sensor 430 and a signal proportional to the amount of rotation is transmitted to controller 440. Controller 440 then computes a tilt angle of sample 330 based on this signal. Other mechanisms for tilting a stage or platform is known in the art and may be used with the invention in place of mechanism 400.

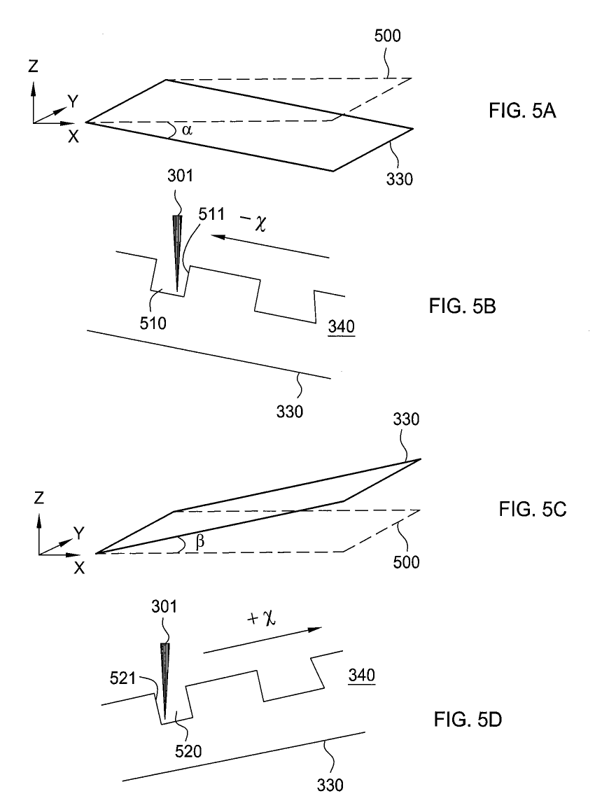

FIG. 5A is a schematic illustration of sample stage 330 with a clockwise tilt of α degrees. The clockwise tilt is with respect to an imaginary plane 500 that is perpendicular to a z-scanning direction of probe 301. When sample stage 330 is tilted clockwise, it is preferable to scan sample 340, which is mounted on sample stage 330, in a −x direction with respect to probe 301. This means that second scanner 320 is moving sample stage 330 in the +x direction. FIG. 5B illustrates how, with this arrangement, a probe 301 can reach a side surface 511 of trench 510 that is formed in sample 340.

FIG. 5C is a schematic illustration of sample stage 330 with a counterclockwise tilt of β degrees. The counterclockwise tilt is with respect to an imaginary plane 500 that is perpendicular to a z-scanning direction of probe 301. When sample stage 330 is tilted counterclockwise, sample 340, which is mounted on sample stage 330, is scanned in a +x direction with respect to probe 301. This means that second scanner 320 is moving sample stage 330 in the −x direction. FIG. 5D illustrates how, with this arrangement, a probe 301 can reach a side surface 521 of trench 520 that is formed in sample 340.

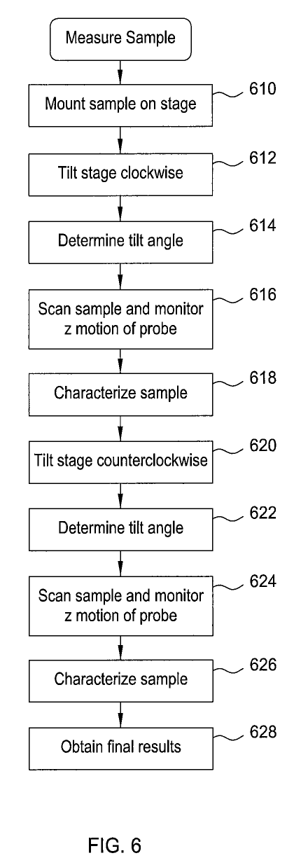

FIG. 6 is a flow diagram of a method for measuring a sample using an SPM, according to an embodiment of the invention. At step 610, a sample is mounted on sample stage 330. Then, at step 612, a clockwise tilt is imparted to sample stage 330. The clockwise tilt angle is determined at step 614 using sensor 430 and controller 440. Scanning of the sample in a forward direction (−x direction shown in FIG. 5A) begins at step 616 and is carried out by second scanner 320. During step 616, the movement of probe 301 in the z direction is monitored and recorded by controller 440. Also, simultaneously with the monitoring of the movements of probe 301, first scanner 310 is driven to scan probe 301 by the same amounts. At step 618, the sample surface is characterized based on the movements of probe 301 during step 616 and the angle determined at step 614.

At step 620, a counterclockwise tilt is imparted to sample stage 330. The counterclockwise tilt angle is determined at step 622 using sensor 430 and controller 440. Scanning of the sample in a reverse direction (+x direction shown in FIG. 5C) begins at step 624 and is carried out by second scanner 320. During step 624, the movement of probe 301 in the z direction is monitored and recorded by controller 440. Also, simultaneously with the monitoring of the movements of probe 301, first scanner 310 is driven to scan probe 301 by the same amounts. At step 626, the sample surface is characterized based on the movements of probe 301 during step 624 and the angle determined at step 622.

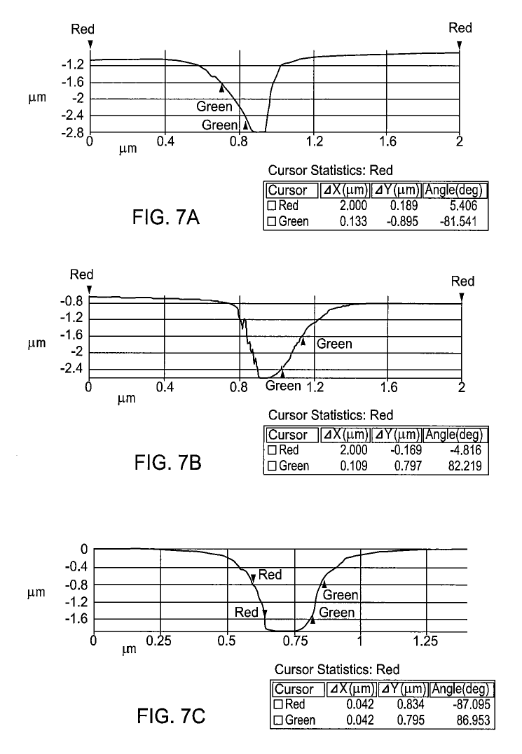

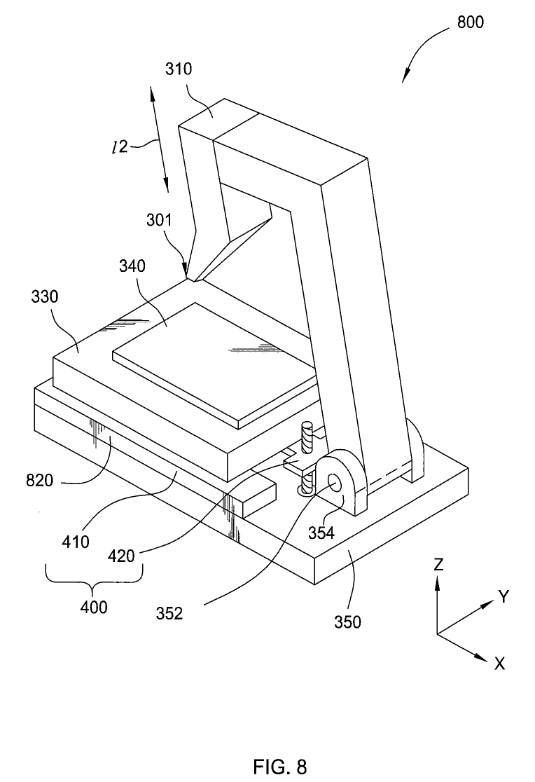

The final results of the sample surface are generated by controller 440 at step 628. Controller 440 does this by combining or stitching together the characterized results from step 618 and step 626. FIG. 7A is a surface contour plot of a sample that is generated from measurements of a sample mounted on a sample stage with a clockwise tilt. FIG. 7B a surface contour plot of a sample that is generated from measurements of a sample mounted on a sample stage with a counterclockwise tilt. FIG. 7C illustrates a surface contour plot that is generated from combining the measurements of a sample mounted on a sample stage with a clockwise tilt and the measurements of a sample mounted on a sample stage with a counterclockwise tilt.

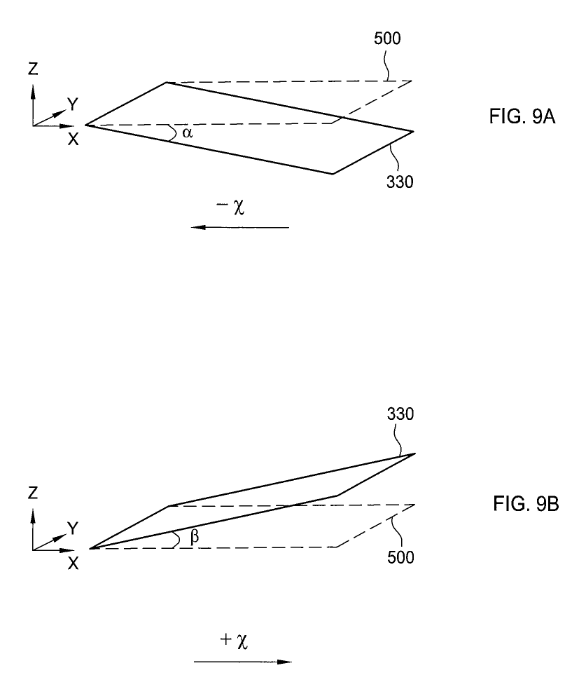

FIG. 8 is an SPM 800 according to a second embodiment of the invention. SPM 800 is identical to SPM 300, except that the x-y scanner (i.e., a second scanner 820) is mounted below mechanism 400 for tilting sample stage 330. As a result, second scanner 820 is not tilted and the x, y and z scanning directions are orthogonal with respect to one another, such that the z direction is perpendicular to the x-y plane. With this arrangement, during forward and reverse scans while sample stage 330 is tilted, the directions of forward and reverse scans are not parallel to the sample measurement plane as shown in FIGS. 9A and 9B.

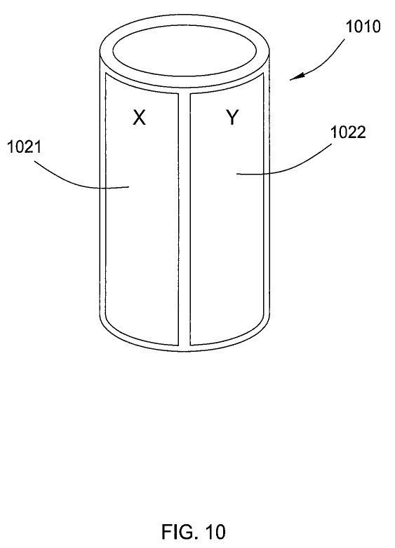

FIG. 10 illustrates a scanner used in an SPM according to a third embodiment of the invention. The SPM according to the third embodiment is identical to SPM 800 except that the x-y scanner and the z-scanner is formed as a piezoelectric tube scanner 1010 shown in FIG. 10 and replaces first scanner 310 of SPM 800. Therefore, in the SPM according to the third embodiment, the sample stage is not moved by the x-y scanner. Instead, probe 301 is scanned in the x, y, and z directions. Piezoelectric tube scanner 1010 includes four segmented outer electrodes and they alternate between x-sections 1021 and y-sections 1022. Probe 310 is moved in the x-direction by applying a voltage of opposite signs to sections 1021 of piezoelectric tube scanner 1010. Probe 310 is moved in the y-direction by applying a voltage of opposite signs to sections 1022 of piezoelectric tube scanner 1010. Probe 310 is moved in the z-direction by applying a voltage of the same sign to all four sections of piezoelectric tube scanner 1010.

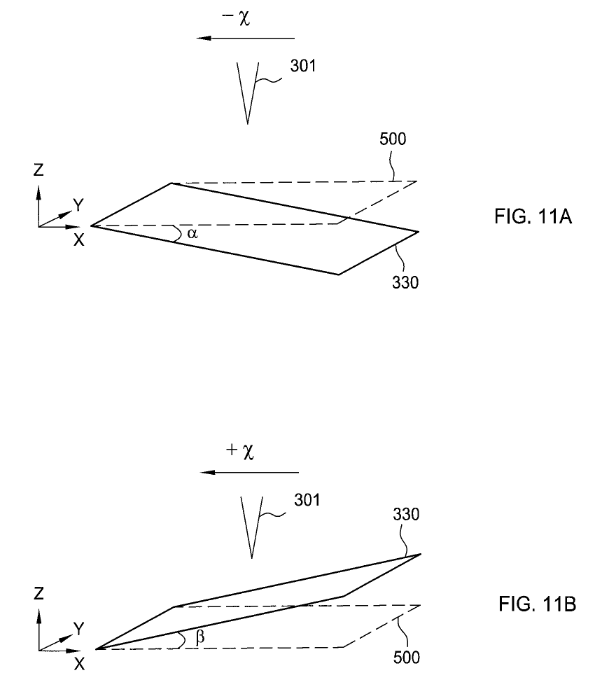

FIGS. 11A and 11B illustrate sample scanning directions with respect to a tilted sample measurement plane when the scanner of FIG. 10 is used. In FIG. 11A, when sample measurement plane is tilted clockwise, probe 310 is scanned in the −x direction, which is not parallel to the sample measurement plane. In FIG. 11B, when sample measurement plane is tilted counterclockwise, probe 310 is scanned in the +x direction, which is not parallel to the sample measurement plane.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A scanning probe microscope comprising:
a probe;
a first scanner for moving the probe in a first direction;
a tilting stage defining a sample measurement plane that is not perpendicular to the first direction;
a second scanner for changing the relative position of the probe and the sample measurement plane in second and third directions, and
a controller that is programmed to generate measurement results based on the movements of the probe in the first direction and an angle by which the sample measurement plane is tilted with respect to a plane that is perpendicular to the first direction.

2. The scanning probe microscope according to claim 1, wherein the second and third directions define a plane that is perpendicular to the first direction.

3. The scanning probe microscope according to claim 1, wherein the second and third directions define a plane that is parallel to the sample measurement plane.

4. The scanning probe microscope according to claim 1, further comprising a sensor that generates signals that are used to determine the angle by which the tilting stage is tilted with respect to the plane that is perpendicular to the first direction.

5. The scanning probe microscope according to claim 4, further comprising an actuator for tilting the tilting stage with respect to the plane that is perpendicular to the first direction.

6. The scanning probe microscope according to claim 1, further comprising an actuator for tilting the first scanner so that an angle formed by an axis that is co-linear with the first direction and the sample measurement plane can be changed.

7. The scanning probe microscope according to claim 1, wherein the second scanner moves the probe within a plane defined by the second and third directions.

8. The scanning probe microscope according to claim 1, wherein the second scanner moves the tilting stage within a plane defined by the second and third directions.

9. A method for measuring a sample using a scanning probe microscope having a probe, a sample stage having a sample mounted thereon, a first scanner for moving the probe in a first direction, and second scanner for scanning the sample in second and third directions, said method comprising:
(a) tilting the sample stage so that the sample stage defines a sample measurement plane that is not perpendicular to the first direction; and
(b) scanning the sample within a plane defined by the second and third directions and monitoring movements of the probe in the first direction during said scanning.

10. The method according to claim 9, wherein the plane defined by the second and third directions is parallel to the sample measurement plane.

11. The method according to claim 9, wherein the plane defined by the second and third directions is not parallel to the sample measurement plane.

12. The method according to claim 9, wherein, during scanning in step (b), the probe is moved within a plane defined by the second and third directions.

13. The method according to claim 9, wherein, during scanning in step (b), the sample stage is moved within a plane defined by the second and third directions.

14. The method according to claim 9, further comprising:
measuring an angle by which the sample stage is tilted with respect to the plane that is perpendicular to the first direction; and
generating measurement results based on the movements of the probe in the first direction and the measured angle.

15. The method according to claim 9, further comprising:
(c) tilting the sample stage so that the sample stage defines a new sample measurement plane that is not perpendicular to the first direction; and
then
(d) scanning the sample in a direction that is opposite a direction of scanning in step (b) and monitoring movements of the probe in the first direction during scanning in step (d).

16. The method according to claim 15, further comprising:
generating a first set of measurement results based on the movements of the probe in the first direction during scanning in step (b) and an angle by which the sample stage is tilted with respect to the plane that is perpendicular to the first direction during scanning in step (b);
generating a second set of measurement results based on the movements of the probe in the first direction during scanning in step (d) and an angle by which the sample stage is tilted with respect to the plane that is perpendicular to the first direction during scanning in step (d); and
combining the first and second sets of measurement results.

17. A method for measuring a sample using a scanning probe microscope having a probe, a sample stage on which a sample is mounted, a probe scanner and a sample scanner, comprising:
(a) scanning the sample with a sample measurement plane being tilted clockwise with respect to a plane that is perpendicular to a scanning direction of the probe scanner; and
(b) scanning the sample with the sample measurement plane being tilted counterclockwise with respect to the plane that is perpendicular to the scanning direction of the probe scanner.

18. The method according to claim 17, further comprising:
generating a first set of measurement results based on the movements of the probe during scanning in step (a) and a tilt angle of the sample measurement plane during scanning in step (a);
generating a second set of measurement results based on the movements of the probe during scanning in step (b) and a tilt angle of the sample measurement plane during scanning in step (b); and
combining the first and second sets of measurement results.

19. The method according to claim 18, further comprising:
determining the tilt angle of the sample measurement plane during scanning in step (a); and
determining the tilt angle of the sample measurement plane during scanning in step (b).

20. The method according to claim 17, wherein the direction of scanning in step (a) opposite to the direction of scanning in step (b).

21. The method according to claim 17, wherein the direction of scanning in steps (a) and (b) are parallel to the sample measurement plane.

22. The method according to claim 17, wherein the direction of scanning in steps (a) and (b) are perpendicular to the scanning direction of the probe scanner.

23. The method according to claim 17, further comprising:
tilting the probe scanner to change an angle formed by an axis that is co-linear with the probe scanning direction and the sample measurement plane.

24. The method according to claim 17, wherein the sample scanner is mounted with the probe to move the probe relative to the sample during steps (a) and (b) of scanning.

25. The method according to claim 17, wherein the sample scanner is mounted with the sample stage to move the sample stage during steps (a) and (b) of scanning.
